(19) United States
(12) Patent Application Publication
(10) Pub. No.: US 2009/0159377 A1
(43) Pub. Date: Jun. 25, 2009

(54) Magnetic, Launch Lock Apparatus and Method

(75) Inventors: Steven R. Wassom, Smithfield, UT (US); Morgan Davidson, River Heights, UT (US); Richard Sanders, Smithfield, UT (US)

Correspondence Address: Utah State University Technology;Commercialization Office, 570 Research Park Way, Suite 101, Logan, UT, 84341, US

(73) Assignee: UTAH STATE UNIVERSITY RESEARCH FOUNDATION, North Logan, UT (US)

(21) Appl. No.: 12/337,919

(22) Filed: Dec. 18, 2008

Related U.S. Application Data
(60) Provisional application No. 61/015,625, filed on Dec. 20, 2007.

(51) Int. Cl. B60L 7/00

(52) U.S. Cl. 188/164

(57) ABSTRACT

An apparatus for securing movable elements of a multiple-axis drive mechanism with respect to the fixed base thereof during launch to prevent damage while unpowered. Mating surfaces of the lock secure the mechanism about all three axes of motion. Thus, the drives need to be only sufficiently designed to break free one element of the launch lock from the other element. Tapered or other guiding surfaces of the two elements of the launch lock make it self-aligning, such that mating surfaces are guided together once placed in sufficiently close proximity.

### CROSS-REFERENCE TO RELATED APPLICATIONS

This application claims the benefit of U.S. Provisional Application No. 61/015,625, filed Dec. 20, 2007 entitled “MAGNETIC, LAUNCH LOCK APPARATUS AND METHOD” which application is hereby incorporated by reference herein in its entirety, including but not limited to those portions that specifically appear hereinafter, the incorporation by reference being made with the following exception: In the event that any portion of the above-referenced application is inconsistent with this application, this application supersedes said above-referenced application. U.S. patent application Ser. No. 11/770,666, filed Jun. 28, 2007, is hereby incorporated by reference herein in its entirety.

### THE FIELD OF THE INVENTION

This invention relates to mechanisms with multiple axes of motion, typically for aircraft and spacecraft applications and, more particularly, to novel systems and methods for locking such mechanisms during launch.

### BACKGROUND

Mechanisms with multiple axes, mounted and driven from a platform such as a satellite, are subject to acceleration forces during launch. Such mechanisms are typically not powered during launch, so some means must be employed to prevent damage. Mechanical latching systems are problematic in that they typically require additional drives, actuators, and controls as well as latches. They also introduce additional risk as another mechanism that may fail. They also require additional power.

Many require human intervention, precise alignment, or both for pins, catches, and so forth to be set, or reset, for later removal by solenoids or other drives. Thus, it would be an advance in the art to provide a simple locking system that did not require additional motors or solenoids, high precision, or human intervention for securing during launch a mechanism and releasing it for operation thereafter.

### BRIEF SUMMARY OF THE INVENTION

In view of the foregoing, an apparatus and method in accordance with the invention provide a magnetic lock relying on a magnet which may be electrically actuated, or a permanent magnet. A mating closure, such as a plate or other latching piece, configured, for example, as a plate or piloted, magnetically-retained cup, may be secured by the magnet with a force imposed by the magnet. Adjustment mechanisms to control a gap between the magnet and the closure may render the magnet's effective attraction force adjustable. A magnetic metal such as iron or a magnetic stainless may form a mount to receive the magnet and may direct magnetic flux. This mount or housing about the magnet may include an adjustment mechanism. The adjustment mechanism may control a gap between the magnet and the closure, or other constrained piece, in order to control magnet forces therebetween securing the lock.

A self-piloting feature may be added by shaping the housing and the closure to taper and to have a resulting mating fit when closed. This configuration may also provide securement against displacement along or about all three principal, independent axes of motion.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of one embodiment of a multi-axis mechanism, in this case, a steering mirror assembly suitable for and tested with a magnetic lock in accordance with the invention; and

FIG. 2 is one embodiment of a magnetic lock, as applied to securing the mirror structure of the apparatus of FIG. 1.

### DETAILED DESCRIPTION OF THE PREFERRED EMBODIMENTS

In view of the foregoing, an apparatus and method in accordance with the invention provide electro-mechanical drivers to drive movement of an optical element (e.g., mirror, optics, focal plane, etc.) for aiming.

Launch accelerations result in substantial reaction forces for all masses on board a launch vehicle. For example, a satellite containing a multi-axis mechanism includes masses that must be accelerated. Thus, under a launch acceleration, their inertia results in an inertial force that must be counteracted to prevent the hardware from displacing, colliding against other components, damaging drives, or the like.

However, since the mechanism is not powered during launch, some means must be employed to prevent motion and damage.

In one embodiment of an apparatus and method in accordance with the invention, a magnetic lock is designed to self-pilot, thus making alignment a very simple matter. Meanwhile, magnetic forces may be adjustable by controlling spacing between a magnet and a secured piece or element acting as a closure held thereby

A housing, acting as a base or mount for a magnet, may double as a flux guide for the magnetic flux of the magnet. This is so even for a permanent magnet, by making a mount of a magnetic metal material. In one embodiment, the mount for the magnet may be formed with a taper, matched to a mating taper of the closure (secured piece held by the magnet). Thus the magnetic lock may be designed to self-pilot, making alignment a much simpler matter. The mating taper and closure also serve to prevent motion with respect to multiple axes.

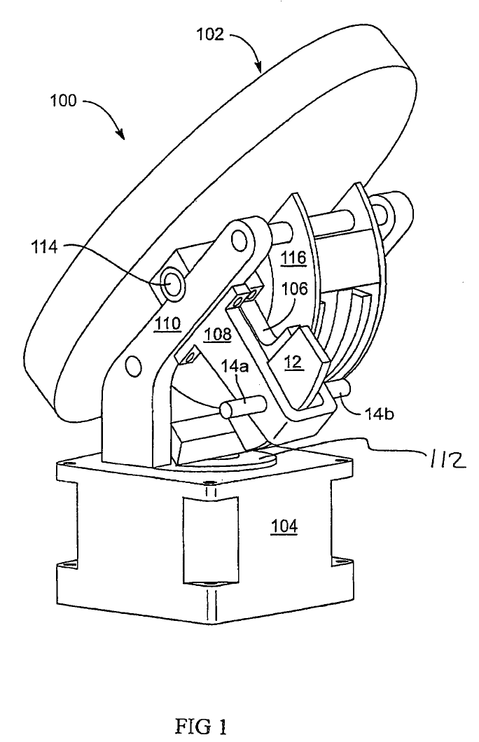

Referring to FIG. 1, an apparatus in accordance with the invention was implemented in a system 100 for stabilizing a fine steering mirror 102 or mirror 102. In the illustrated embodiment a motor 104 served as the azimuth drive for the system 100. Meanwhile, a mount 106 connected the movable element 12 rigidly to move with the mirror 102. More details are included in U.S. patent application Ser. No. 11/770,666, filed Jun. 28, 2007.

Sensors 14a, 14b were secured to a mount 108 that did not move with the mirror 102. A yoke 110, fixed to a turntable 112, held a drive motor 116. The mirror 102 was mounted on a flexible pivot member to rotate about a rotational axis 114. The axis 114 could have been an axle, but was not in this case, in order to provide certain other mechanical and thermal benefits.

Connected between the yoke 10 and the mirror 102 were the drive motor 116 and the flexible pivot system, in order to rotate or pivot the mirror 102 with respect to the yoke 110, and turntable 112, in the elevation direction. Meanwhile, the yoke 110 and 116 moved in the azimuth direction via the turntable 112 and the motor 104. In the illustrated embodiment, a moveable element 12 operated as a segment of a circular or arcuate wedge 12 having a thickness that varied along its circumferential direction, the wedge 12 pivoting on an arm extending radially. The motor 104 caused the turntable 112 to rotate, which in turn caused mirror 102 to rotate in the azimuth direction.

The performance parameters of pointing and stabilizing the mirror 102 of the system 100 demonstrated low energy use, excellent isolation for thermal and mechanical losses, negligible friction, and a very high repeatability and precision.

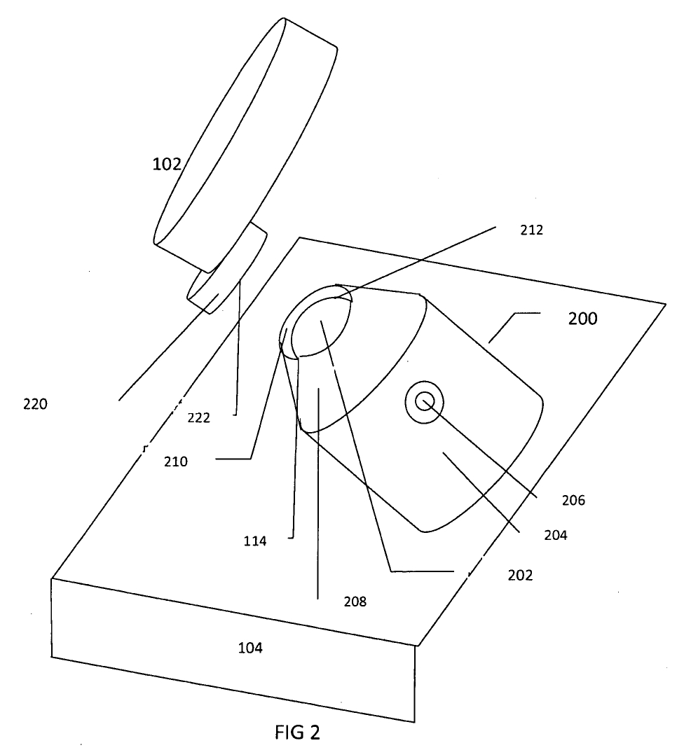

Referring to FIG. 2, the system 100 was fitted with a magnetic launch lock 200, in accordance with the invention. The housing of motor 104 may be thought of as fixed, or a fixed item with respect to the platform (e.g., satellite, rocket, aircraft) carrying the mirror 102. Meanwhile, the mirror 102 is pivotably mounted with respect to the motor 104, in order to be guided and driven in operation.

Meanwhile, during launch, the mirror 102, being unpowered in both axes may be damaged due to excessive motion cause by launch acceleration.

In one embodiment of an apparatus and method in accordance with the invention, a lock 200 may secure the mirror 102 in fixed relation with respect to the motor 104.

In one embodiment, a lock 200 may include a magnet 202 secured inside or otherwise connected to a housing 204 or base 204. The magnet 202 may be contained in a cup 212, which is threaded into the housing 204. The housing 204 may be configured to also act as a flux guide for the magnetic flux created by the magnet 202. Accordingly, in certain embodiments the housing 204 may be manufactured of a suitable magnetic material, such as iron, magnetic stainless, or the like.

The housing 204 may include a threaded cup 212 and a set screw 206 to position the magnet 202 with respect to the housing 204. In one embodiment, the threaded cup 212 may act as the adjustment mechanism to move the magnet 202 to a particular position with respect to the housing 204, the set screw 206 is then used to fix the position. In the illustrated embodiment, the magnet 202 is a right circular cylinder fitted to a housing 204 having an aperture sized to receive the magnet 202.

The housing 204 may include a pilot surface 208. The pilot surface 208 may have a tapered, circular cross-section, a hemisphere, a taper of pyramidal shape, or the like. In the illustrated embodiment, the pilot surface 208 is conical, representing a frustum of a cone. As the conical pilot surface 208 ends at the edge 214, where it meets the aperture in the housing 204, a frustum is formed.

The magnet 202 may be adjusted by the threaded cup 212 to extend out and away from the pilot surface 208. However, in the illustrated embodiment, the magnet 202 is set within the aperture in the housing 204, providing a setback 210 or air gap 210 (or simply a gap 210). Spacing the outer surface of the magnet 202 “down” into tile aperture, (e.g., below or inside the edge 214 of the pilot surface 208,where the pilot surface 208 meets the aperture of the housing 204), creates an air gap 210 but permits the housing 204 to still guide magnetic flux to tile closure 220. Thus, as the magnet 202 retreats into the aperture or into the housing 204, a decay in magnet force corresponds to the setback 210 from the surface of the magnet 202, according to the laws of magnetism.

In opposite, mating relation to the housing 204, a closure 220 is secured to the mirror 102. Actually, the housing 204 may be associated with the mirror 102 and the closure 220 may be associated with the base 104. However, minimizing the mass and its moment of inertia on the moving mirror 102 improves the dynamic response of the system.

A piloting surface 222 inside the closure 220 may be matched to fit in mating relation to the pilot surface 208 of the housing 204. As a practical matter, the magnet 202 may itself be shaped. However, there is no need to do so. The housing 204 may be manufactured of a suitable magnetic material, responsive to magnetic flux and capable of extending the magnetic reach of the magnet 204. Likewise, the closure 220 may be formed of a magnetic material similar to that of the housing 204.

In certain embodiments, the housing 204 may be fixed rigidly with respect to the motor 104. Likewise, the closure 220 may be fixed rigidly to the mirror 102, or a substrate thereof. Alternatively, a pre-determined amount of flexibility may be provided. Thus, the piloting surfaces 208, 222 may be able to be fitted more precisely.

Alternatively, the housing 204 and closure 220 may be fitted together, with the magnet 202 in place. Any mounting hardware or brackets may be adjusted to ensure installation of the housing 204 and closure 220 with a suitably precise alignment. Thereafter, the movement of the mirror 102 toward the motor 104 may engage the closure 220 by the magnet 202 and its associated housing 204. Meanwhile, the piloting surfaces 208, 220 engage one another, and come into a mating relationship, the magnet 202 providing the force to keep the closure 220 in proximity to the magnet 202.

In practice, controlling magnetic forces of permanent magnets is not a readily controllable design parameter, nor adjustable on site. Nevertheless, providing a setback 210 that can be arbitrarily adjusted by moving the magnet 202 requires only screwing the cup 212 and fixing it with the set screw 206. Virtually any value of magnetic force available, up to a maximum capability of the magnet 202, may be set. Thus, the air gap 210 or setback 210 may reduce the value of the magnetic force to an appropriate level.

Typically, an appropriate level of magnetic force is a force less than the motive capability of the elevation drive driving the mirror 102 with respect to the azimuth motor 104. The housing 204 may be oriented in such a way that the pilot surfaces 208, 220 support the actual forces due to launch acceleration. Thus, the launch lock 200 transfers the support of the mirror 102 through the lock 200, and directly to the motor 104. Those forces need not be supported by the drives of the mirror 102.

The mirror 102 is disengaged from the lock by movement, urged by the elevation drive, to draw the closure 220 axially away from the magnet 202 (axially with respect to the magnet 202 and housing 204). This action requires more force, than the actual stabilizing or holding force presented by the pilot surfaces 208, 220 during launch.

Some of the advantages of the lock 200 in accordance with the invention include the lack of the need for an electrical circuit to maintain the force of the magnet 202. An electromagnet may be used as a magnet 202, but a permanent magnet functions adequately. The adjustment mechanism provides for a simple adjustment with a broad range of force available to design or calibrate the lock 200 to accommodate the forces available from the elevation drive of the mirror 102.

The system can also be locked again by using the elevation drive and azimuth drive to reposition the mirror 102 such that the pilot surfaces 208 and 222 are in close proximity, and then removing the power to the drives.

Meanwhile, the lock 200 actually stabilizes the mirror 102 with respect to all three principal axes. Because the shape of the housing 204 resolves forces into its surfaces, the lock 200 may be oriented to support the launch loads in a direction transverse to the axis of symmetry of the magnet 202 and the housing 204. Magnetic forces are augmented or leveraged by the orientation of the housing 204 and enclosure 220 with respective pilot surfaces 208, 222. A properly designed orientation provides greater launch support than the actual magnet forces alone.

In the illustrated embodiment, the force of the magnet 202 in the housing 204 was set to exceed the forces necessary to resist forces of launch accelerations. Meanwhile, the elevation drive for the mirror 102 was sized to exceed the effective force of the magnet 202 exerted to hold the closure 220 against the housing 204. Various types of magnets may include neodymium-iron-boron magnets, samarium-cobalt magnets, or the like.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus comprising:
a mount comprising a fixed portion and a movable portion, selectively positionable with respect to the fixed portion
a drive sized to move said movable portion with respect thereto at an acceleration;
said drive having a maximum force corresponding to the mass of said movable portion and the acceleration;
a lock comprising a base secured to said fixed portion and a closure secured to said movable portion; and
said lock, further comprising a magnet adjustably secured to said base at a distance, with respect to said closure, selectable to control the force by said magnet on said closure.

2. The apparatus of claim 1 wherein:
said drive is secured to said fixed portion.

3. The apparatus of claim 1 wherein:
said drive is secured to said movable portion.

4. The apparatus of claim 1 wherein:
said base is matingly fitted to said closure.

5. The apparatus of claim 1 further comprising:
an adjustment to provide an air gap, controlling the magnetic force of said magnet with respect to said closure by selectively displacing said magnet with respect to said closure.

6. The apparatus of claim 5 wherein:
said magnet and said base are threaded to allow for adjustment of said air gap.

7. The apparatus of claim 6 further comprising:
a set screw in said base to lock motion of said magnet.

8. The apparatus of claim 1 further comprising:
a mating cone shaped to provide restraint in all directions of translation.

9. The apparatus of claim 1 further comprising:
a mating surface to provide restraint in all directions of translation.

10. The apparatus of claim 1 further comprising:
a hemispherical shape surface to provide restraint in all directions of translation.

11. The apparatus of claim 1 further comprising:
a pyramidal shape surface to provide restraint in all directions of translation.

12. The apparatus of claim 1 wherein:
said magnet is an electromagnet.

13. The apparatus of claim 1 wherein:
said magnet is a permanent magnet.

14. A method for temporarily immobilizing an apparatus comprising:
securing a magnet within a housing to a base so that said magnet position is adjustable; mounting a closure to a movable apparatus;
selecting said magnet position so as to control the force by said magnet on said closure; and detaching said magnet from said closure by moving said apparatus with a drive.

15. The method of claim 14 further wherein:
said drive is secured to said base.

16. The method of claim 14 further wherein:
said drive is secured to said apparatus.

17. The method of claim 14 further wherein:
said housing is matingly fitted to said closure.

18. The method of claim 14 further comprising:
restraining motion of the apparatus in all directions of translation by positioning a mating cone shaped surface to provide restraint around said magnet.

19. The method of claim 14 further comprising:
restraining motion of the apparatus in all directions of translation by positioning a mating a hemispherical shaped surface to provide restraint around said magnet.

20. The method of claim 14 further comprising:
restraining motion of the apparatus in all directions of translation by positioning a mating a pyramidal shaped surface to provide restraint around said magnet.
